(19) United States
(12) Patent Application Publication
(10) Pub. No.: US 2005/0241674 A1
(43) Pub. Date: Nov. 3, 2005

(54) Louvered spray guard for trapping overspray during spray washing of silk screens

(76) Inventor: James W. Demchuk, Bolingbrook, IL (US)

Correspondence Address: LAW OFFICE OF BRIAN R. RAYVE, P.O. Box 11586, Salt Lake City, UT, 84147-0586, US

(21) Appl. No.: 10/835,877

(22) Filed: Apr. 30, 2004

(51) Int. Cl. B08B 7/04; B08B 3/04

(52) U.S. Cl. 134/10; 134/198; 134/104.2; 134/34

(57) ABSTRACT

A louvered spray guard for receiving and trapping overspray during spray washing of ink from silk screens. The spray guard includes an upright support frame with a rectangular backing sheet sized to stop overspray behind the silk screen. A plurality of narrow vertical strips are affixed edgewise to the backing sheet forming a plurality of vertical channels. A plurality of rectangular deflector blades are pivotally mounted between the vertical members spaced forward of the backing sheet hanging downwardly in slightly overlapping manner. The blades are biased to a closed position by gravity to cover the backing sheet. A transverse angle member seals off upper ends of the channels. A transverse strip across the lower front of the vertical strips leaves bottom ends of the channels open for discharge of trapped overspray. Momentum of the overspray contacting the blades causes individual rearward pivoting thereof to an open position during contact to pass the overspray downwardly through the channels without splashing off the backing sheet. A spray collection system utilizes the spray guard along with a main frame to support the spray guard and the silk screen in a vertical position. The overspray drains from the spray guard into a collection tank for subsequent disposal.

### BACKGROUND OF THE INVENTION

1. Field

The present invention relates generally to spray washing devices and methods, and more specifically to spray washing ink from silk screens used in printing.

2. State of the Art

Silk screen printing is commonly used to print items such as signs and other advertising, clothing such as T-shirts, posters and other printed art, circuit boards, and other relatively low volume, custom printing applications. Silk screen printing is conducted using

stenciling devices called silk screens, also known as screen printing plates, screen stencils, and printing screens. Hereinafter, the term “silk screen” shall be used to describe all such stenciling devices regardless of the specific design thereof. Printing inks, paint, and dyes (hereinafter all referred to as ink) are used with the silk screens to print the desired design on the print items.

Silk screens typically include a rectangular frame made of steel, aluminum, or wood having a central opening. The frame is designed to removably clamp a flexible screen made of woven polyester, nylon, or steel fibers, or other porous, ink pervious material tightly stretched across the central opening. Alternatively, the screen may be permanently affixed to the frame such as by stapling to a wood frame. Areas where the ink is not desired to flow through are masked to block the printing ink. Areas of the screen where the ink is to flow through onto the item to be printed remain unmasked. The masking is done using a photographic-like process wherein a liquid emulsion is applied to at least an upper surface of the screen within the frame. An image of the desired masked areas is shined as light onto the liquid emulsion causing solidification or fixing of those areas to fill in the openings between fibers in the screen. The areas on which the light does not shine remain liquid, being the desired image to be printed onto the item, which is subsequently washed away from the openings between fibers in the screen for the ink to flow. Other masking methods are used in silk screen printing such as using paste-up materials such as cut-out plastic films or film strips. The masking produces a stencil on the screen with the desired design to be printed.

Silk screen printing is done by placing the silk screen on top of the item to be printed which is laid on a flat support surface. The ink is applied to the top surface of the screen within the frame and squeegeed to fill the openings between the fibers in the unmasked areas of the screen. The item receives the ink through the openings and the silk screen is removed from the now printed item. The printing ink includes a solution of pigments and binders contained in a non-aqueous liquid which evaporates to dry the ink. Therefore, after the silk screen is removed, the ink on the printed item quickly dries. The silk screen is continuously used to print additional items before the ink can dry on the screen.

The cleaning of silk screens to remove the ink following printing has historically been done using a non-aqueous liquid hydrocarbon solvent and rags in large sink or wash basins. Such cleaning is done in open air wherein the silk screen is placed in the wash basin and adhering ink, emulsion, or other undesirable debris is rinsed away using a the solvent or other cleaning fluid which dissolves the ink. The solvent may be applied by dipping the silk screen into the solvent, painting the solvent onto the silk screen, or spraying the solvent onto the silk screen if so desired to speed up the process. Manual scrubbing using the rags is also done to remove ink, emulsion, or undesirable debris as needed. The silk screens are then spray washed with water to flush remaining solvent and ink down the drain. Oftentimes the frame and corners of the silk screen are covered with masking tape or other materials prior to use in printing to round the otherwise square edges thereof. This helps to prevent splashing during spray washing of the silk screen. Silk screens are relatively expensive to buy and are often reused following completion of printing the particular design using the stencil thereon. If the silk screen is to be reused, the stencil is completely removed from the screen following cleaning for subsequent application of a new stencil. The stencil is typically removed using a jet of high pressure water to lift the fixed emulsion or film from the fabric material. Any tape is typically also removed at this time.

A first problem with the open air use of solvents to clean silk screens is their hydrocarbon composition, toxic disposition, and inevitable inhalation of vapors from the solvent by persons during the cleaning process which create environmental concerns. Respirators may be worn by those persons associated with the cleaning process though this may be uncomfortable due to heat build-up on the wearer's face if worn for extended periods of time. A second problem is the high flammability of such solvents and the need to vent the cleaning area to prevent build-up of combustible levels of vapors. Such vapors may not be directly ventable to atmosphere due to government environmental regulations. A third problem is that the ink, emulsion, or other undesirable debris removed from the silk screens during washing often are often toxic, being hazardous materials including heavy metals such as lead or chromium based ink pigments. Such hazardous materials are not able be simply drained into a drain into the sewer system along with the washing liquid. Rather, the washing liquid containing the hazardous materials typically must be captured and sent in drums to special depositories for disposal or separation of the hazardous materials therefrom. In fact, many countries do not allow the use of the above cleaning method for silk screens. Even if a biodegradable solvent is used, the water insoluble ink itself is a pollutant.

Various cleaning machines and cleaning methods have been formulated in recent years which attempt to solve the environmental concerns associated with using hydrocarbon solvents to clean silk screens by conducting cleaning in closed air environments. Such machines have a cabinet with an enclosed chamber in which the silk screen to be cleaned is placed. One or more fixed or moving nozzles spray pressurized solvent at the silk screen to remove the ink, emulsion, or other undesirable debris therefrom. Some machines use higher pressure nozzles designed to remove the stencil from the screen for subsequent application of a new stencil. A hydrocarbon solvent, an aqueous solvent, or plain water may be used for stencil removal. In either type of machine, the solvent, ink, emulsion, and other undesirable debris are directed to a collection tank for subsequent disposal or recycling, sent directly to the sewer system such as through a floor drain, or processed such as by filtering out the solid debris and the sewer system.

Some of these cleaning machines and cleaning methods are disclosed in various issued patents. For example, in U.S. Pat. No. 4,561,903 issued to Blaul on Dec. 31, 1985 is disclosed a method of solvent spray cleaning parts in a chamber of an enclosure. The method utilizes a spray nozzle disposed within the chamber to direct a solvent spray onto the enclosed parts by eye looking through a viewing window of the enclosure. The solvent spray is confined within the chamber so as not to expose the operator or the outside environment to vapors and liquid solvent. Air within the chamber and the liquid solvent are continually recycled during operation to keep down the concentration of vapor in the air within the chamber so as not to fog the viewing window and to reuse the solvent.

In U.S. Pat. No. 3,580,261 issued to Key on May 25, 1971 is disclosed a printing screen cleaner. The printing screens are carried by an overhead conveyor through a cleaning tunnel. In a central section of the tunnel opposed rows of spray heads direct solvent onto the screens. The solvent with removed debris from the screens is drained into a separating tray to settle out some of the debris from the solvent. The solvent further drains into a sump and is pumped back to the spray heads. Opposing doors at opposite ends of the central section are pushed open and are biased closed by the printing screens moving through the tunnel on the overhead conveyor. A fan draws air in from respective ends of the tunnel which is discharged out a stack to atmosphere. A fire quenching system includes a plurality of spray heads disposed in the tunnel.

While these cleaning machines and cleaning methods which use closed air environments may do an adequate cleaning job, they have several problems. Firstly, they are expensive to purchase, operate, and maintain. Secondly, they are typically permanently installed in a fixed location due to their size, weight, and plumbing requirements taking up considerable floor space.

As more biodegradable, less toxic cleaning liquids have been developed in recent years open air spray washing without using enclosed cleaning machines becomes more feasible. Such biodegradable washing liquids are also less volatile, less flammable, water soluble, and easier to dispose of than hydrocarbon solvents for spray washing silk screens. Therefore, the spray washing may be conducted outside of any enclosed chambers without fear of exposure to toxic fumes, explosions, and the like. Such open air spray washing may be conducted in the wash basins as described above, though spray washing is more efficiently done with some sort of backing sheet or spray guard to stop overspray of the washing liquid passing by or through the silk screen.

Various spray shields and deflectors have been designed over the years for protecting adjacent surfaces when spraying items with washing liquid, paint, and the like. For example, in U.S. Pat. No. 5,853,811 issued to Poague on Dec. 29, 1998 is disclosed a spray shield which is fabricated from suitable sheet material such as cardboard, plastic, tin, or stainless steel. The spray shield is rectangular with peripheral flanges disposed at an upper edge and two side edges thereof, and a trough disposed at a lower edge thereof. The spray shield is placed rearwardly of an item being painted, cleaned or otherwise sprayed. The flanges confine overspray of the liquid which is directed downwardly by gravity into the trough for collection and discharge.

While spray shields and deflectors are adequate for the purpose intended, they suffer from several drawbacks. Firstly, they do not inhibit splashing of overspray which can land on the floor or other undesirable location. Secondly, they do not inhibit vapor propagation into the atmosphere by trapping the washing liquid and directing to an enclosed container for recycling or disposal.

There is a need for an improved device and method for use in spray cleaning and washing of silk screens, or other such items. Improvements include: 1) using the non-hydrocarbon, aqueous cleaning liquids so as to use open air spraying without requiring the operator to use a respirator: 2) trapping the overspray without significant splashing off the spray shield onto the floor; 3) inhibiting vapor propagation from the cleaning liquid into the atmosphere by immediately enclosing the trapped the cleaning liquid; 4) directing the enclosed cleaning liquid with removed ink, emulsion, and undesirable debris into a container for recycling or disposal; 5) being relatively inexpensive to purchase, operate, and maintain; 6) being of a portable, relatively compact design which is lightweight and does not require external plumbing; and 7) is adaptable for use with various spray cleaning and washing devices.

### SUMMARY OF THE INVENTION

The present invention is a louvered spray guard for receiving and trapping overspray of a cleaning or washing liquid (hereinafter both referred to as a washing liquid for purposes of the present invention) during spray cleaning or washing (both hereinafter referred to as spray washing for purposes of the present invention) of an item such as silk screens; a spray collection system for placement on a support surface which utilizes the spray guard to receive and trap the overspray, and further contain the overspray; and a method of spray washing items using the spray guard or the spray collection system.

The louvered spray guard includes a support frame which includes a rear surface adapted to be disposed in a position behind the item to stop the overspray. A plurality of deflector blades are pivotally mounted to the support frame spaced forward of the rear surface. The deflector blades are biased to a closed position substantially covering the rear surface of the support frame from the overspray and define a passageway therebetween with a front opening and a bottom opening adapted for discharge of trapped washing liquid. Momentum of the overspray which contacts the deflector blades causes rearward pivoting thereof during the contact to an open position to pass the overspray into the passageway. There is no substantial splashing of the overspray off the rear surface and downward gravitational drainage through the bottom opening. There is subsequent closing of the contacted deflector blades when momentum of the overspray diminishes. This closing minimizes splashing of the washing liquid while passing through the chamber.

The spray collection includes the louvered spray guard, a main frame adapted to support the spray guard in a generally vertical position for receiving the overspray, and a collection tank. The collection tank has a bottom portion adapted to rest on the support surface and an upper portion adapted to support the main frame. The collection tank has an internal washing liquid collection chamber adapted to receive and hold trapped washing liquid moved thereinto from the spray guard by gravity.

The method of spray washing of an item includes the steps of: 1) providing a louvered spray guard having a plurality of pivotable deflector blades which are biased to a closed position not to pass overspray thereinto; 2) positioning the item for washing in front of the spray guard; 3) directing a spray of washing liquid at the item to remove contaminates therefrom; and 4) receiving and trapping in the spray guard the overspray of the washing liquid directed at the item wherein momentum of the overspray which contacts individual deflector blades causes rearward pivoting thereof during the contact from the closed position to an open position to pass the overspray into the spray guard and stopped against a rear surface thereof while those deflector blades not contacted remain in the closed position without substantial splashing of the overspray off the spray guard.

### THE DRAWINGS

The best mode presently contemplated for carrying out the invention is illustrated in the accompanying drawings, in which:

FIG. 1 is a perspective view of a spray guard in accordance with the present invention as part of a spray collection system which further includes a main frame, a collection tank, and a spray shroud as used with a spray gun emitting a washing spray to clean a silk screen;

FIG. 2, a perspective view of the spray guard alone showing a support frame with a plurality of deflector blades pivotally mounted thereto;

FIG. 3, a bottom plan view of the spray guard to an enlarged scale taken on the line 3-3 of FIG. 2 further showing a plurality of stop members affixed to the support frame to limit pivotal movement of the deflector blades;

FIG. 4, a fragmentary longitudinal vertical sectional view of the spray guard to an enlarged scale taken on the line 4-4 of FIG. 2 showing how the deflector blades pivot under urging of the washing spray;

FIG. 5, a fragmentary front elevational view of the spray guard to an enlarged scale showing the vertically staggered relationship between deflector blades of adjacent columns of blades;

FIG. 6, an exploded perspective view of the spray guard including the support frame, deflector blades, and stop members, the support frame which includes a rectangular backing sheet, a pair of vertical side strips, a plurality of vertical middle strips, an upper angle member, and a lower strip; and

FIG. 7, a perspective view of a single deflector blade to an enlarged scale showing a pivot rod with laterally disposed pivot posts, a rectangular curved panel, and a pair of curved reinforcement ribs 106.

### DETAILED DESCRIPTION OF THE ILLUSTRATED EMBODIMENTS

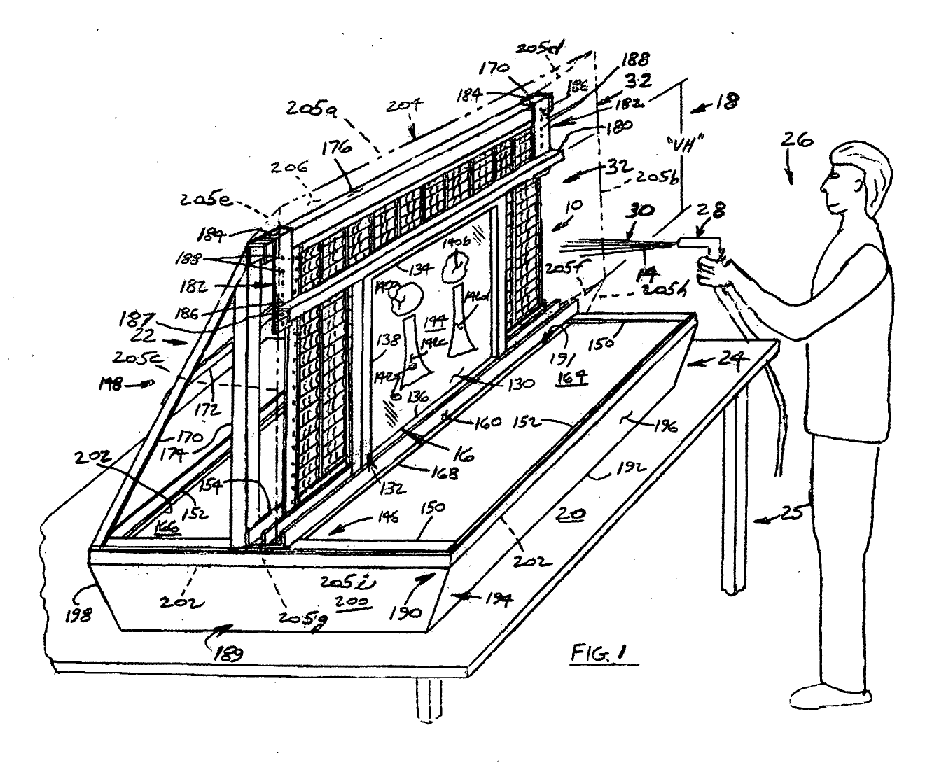

Referring to FIG. 1, therein is shown a louvered spray guard in accordance with the present invention, designated generally at 10, for receiving and trapping overspray 12 of a washing liquid 14 during spray washing of items such as a silk screen 16. Spray guard 10 is shown as part of a spray collection system 18 for placement on a support surface 20 for receiving, trapping, and additionally containing the overspray 12 of washing liquid 14 during spray washing of the silk screen 16. Spray collection system 18 includes a main frame 22 which supports the spray guard 10 over a collection tank 24 resting on the support surface 20 such as of a table 25. A person 26 is shown cleaning the silk screen 16 using a spray gun 28 which emits a spray 30 of the cleaning or washing liquid 14 such as hydrocarbon based solvent or a water based washing liquid. An optional spray shroud 32 is shown to catch the overspray 12 of the washing liquid 14. The spray collection system 18 collects the overspray 12 of washing liquid 14 for recycling or disposal.

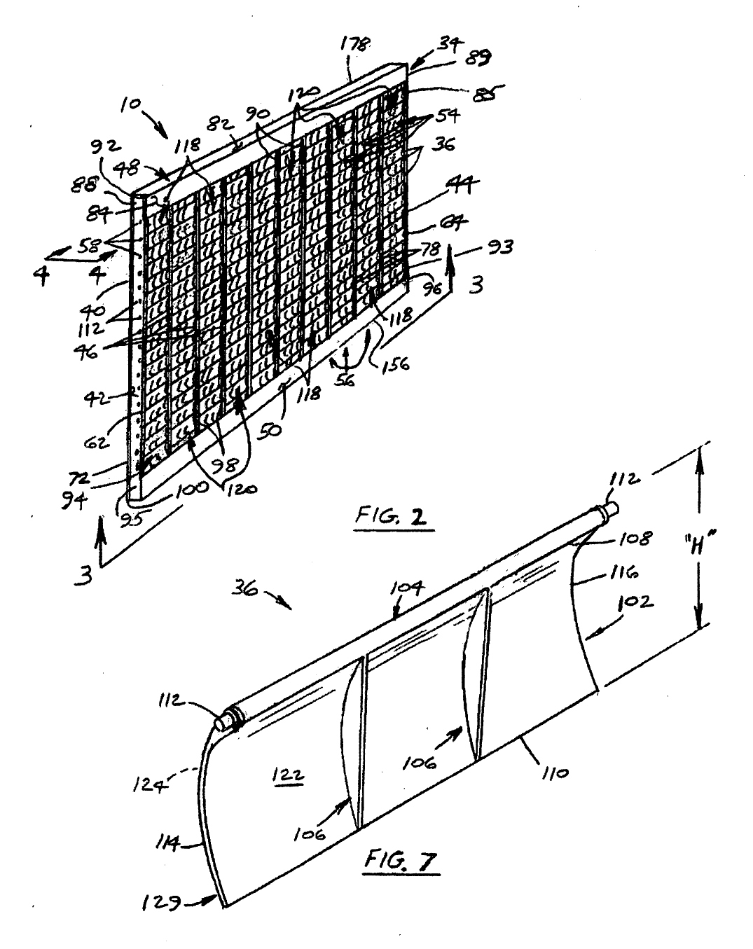

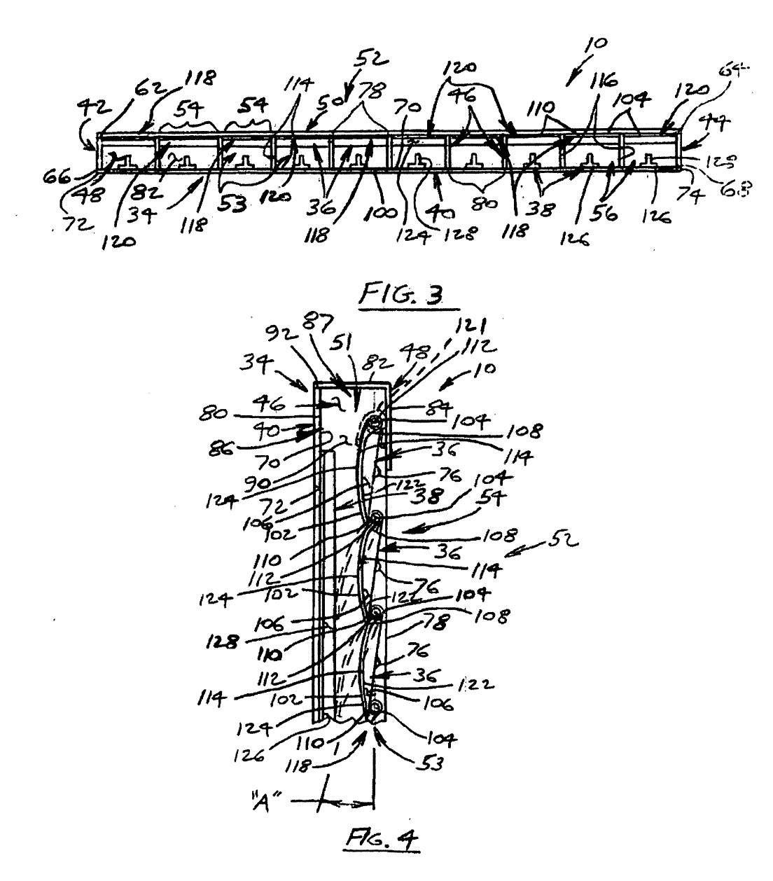

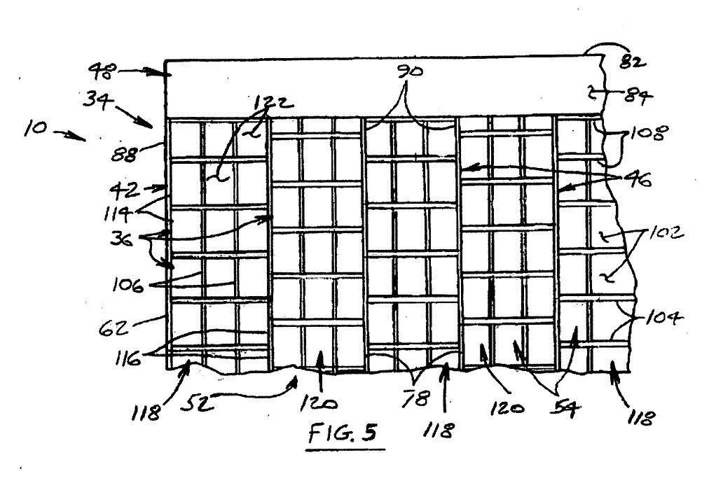

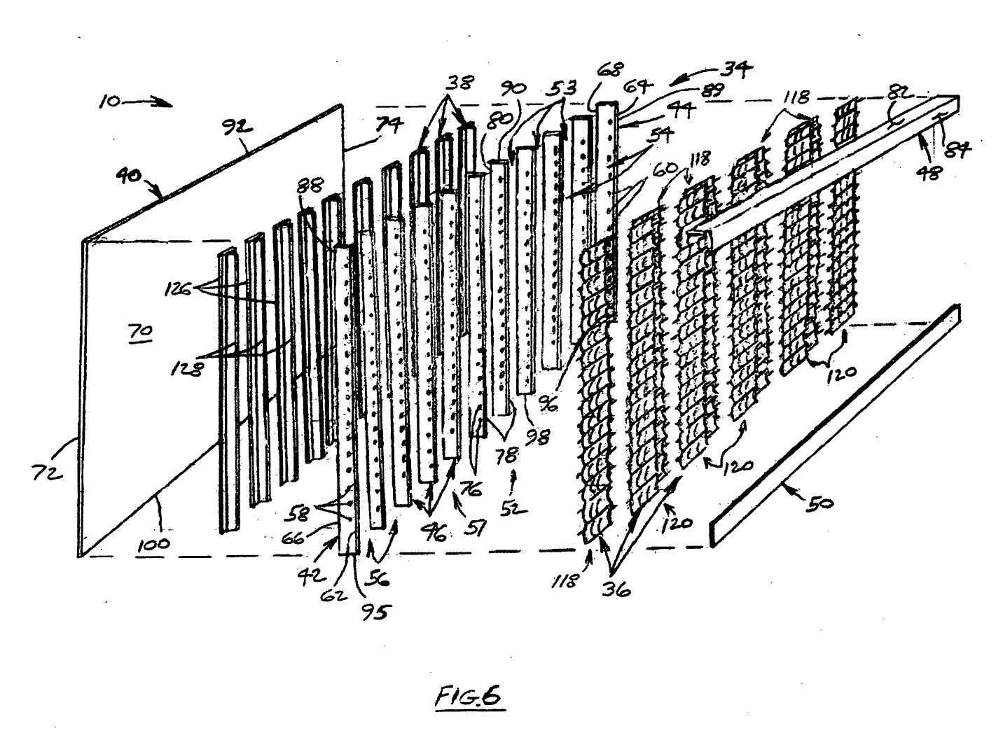

As best shown in FIGS. 2-6, the spray guard 10 includes a support frame 34, a plurality of deflector blades 36 pivotally mounted to the support frame 34, and a plurality of stop members 38. The spray guard 10 shown is wider than it is high, being of a size of about five feet wide, three feet high, and two inches thick which is sufficient to accommodate silk screens 16 of up to about three feet wide by about two feet high. The size may be varied as desired to accommodate silk screens 16 or other such items of various sizes, while being sized to be sufficiently larger than the silk screen 16 or other item to catch the overspray 12. The component parts of spray guard 10 are preferably fabricated from conventional plastic sheet, strip, and angle stock with certain components injection molded from plastic material. Such plastics include polyvinyl chloride, polypropylene, polyethylene, ABS, and the like which are non-reactive with the particular washing liquid and are easily cleanable. The component parts are affixed together where shown such as adhesively.

The support frame 34 is made from a plurality of component parts which include a rectangular backing sheet 40, a plurality of parallel members in the form of a pair of elongate vertical side strips 42 and 44 and a plurality of elongate vertical middle strips 46, an upper angle member 48, and a lower strip 50. The support frame 34 and the deflector blades 36 define a large vertical passageway 51 therebetween with deflector blades 36 covering a large front opening 52 thereof. The middle strips 46 divide the large vertical passageway 51 into a plurality of smaller vertical channels 53 with respective smaller vertical front openings 54 which terminate at respective bottom openings 56 adapted for discharge of trapped washing liquid 14.

The side strips 42 and 44 have respective pluralities of pivot holes 58 and 60 therethrough disposed in substantially linear fashion adjacent respective front edges 62 and 64 thereof. Respective rear edges 66 and 68 thereof are affixed to a front surface 70 of backing sheet 40 at respective side edges 72 and 74 of backing sheet 40 with side strips 42 and 44 disposed in a laterally spaced relationship. The front surface 70 is of substantially planar configuration and serves as a rear surface of support frame 34 adapted to be disposed in a position behind the silk screen 16 to stop the overspray 12. The middle strips 46 have a plurality of pivot holes 76 therethrough disposed in substantially linear fashion adjacent a front edge 78 thereof. Respective rear edges 80 are affixed to front surface 70 of backing sheet 40 between the side strips 42 and 44 with side strips 42 and 44 and middle strips 46 disposed in a mutually laterally spaced relationship which define the vertical channels 53 of the large vertical passageway 51. The upper angle member 48 includes a horizontal leg 82 and a vertical leg 84. The upper angle member 48 is affixed to an upper edge 85 of the support frame 34 covering a plurality of upper openings 86 of the vertical channels 53 and an upper portion 87 of each front opening 54, and to respective upper ends 88, 89, and 90 of side strips 42 and 44, and middle strips 46, and to an upper edge 92 of backing sheet 40. The lower strip 50 is affixed adjacent a lower edge 93 of the support frame 34 covering a lower portion 94 of each front opening 54, and to respective lower ends 95, 96, and 98 of side strips 42 and 44, and middle strips 46, and to a lower edge 100 of backing sheet 40.

Referring to FIG. 7, the plurality of the deflector blades 36 are of substantially rectangular configuration as viewed from the front and are pivotally mounted to the support frame 34 spaced forward of the front surface 70. The deflector blades 36 are of an outwardly convex shape which smoothly transitions the overspray 12 of washing liquid 14 into the vertical channels 53 without splashing. The deflector blades 36 are integrally molded including a rectangular curved panel 102, a pivot rod 104, and a pair of curved reinforcement ribs 106. The pivot rod 104 is joined to a thickened top edge 108 of panel 102. The ribs 106 extend from pivot rod 104 along panel 102 to a bottom edge 110 thereof. A pair of integrally molded pivot posts 112 coaxially extend laterally outwardly from each deflector blade 36. The pivot posts 112 are adapted to be closely pivotally received within respective of the pivot holes 58, 60, and 76 of the side strips 42 and 44, and the middle strips 46. The pivot posts 112 extend coaxially with pivot rod 104 distally of respective side edges 114 and 116 of panel 102 with the panel 102. The deflector blades 36 are slightly flexible so as to pivotally mount to support frame 34 by gentle longitudinally flexing to permit the pivot posts 112 to fit within respective of the pivot holes 58, 60, and 76.

As shown in FIG. 4, the deflector blades 36 are biased to a closed position (solid lines) overlapping one other substantially covering the front surface 70 of backing sheet 40 from the overspray 12. The deflector blades 36 hang downwardly under the influence of gravity, being pivotally mounted to the side strips 42 and 44 and the middle strips 46 disposed so as to position blades 36 within the vertical channels 53 forming staggered vertical blade columns 118 and 120 of deflector blades 36 covering the front openings 54 of vertical channels 53. The deflector blades 36 of adjacent blade columns 118 and 120 are vertically staggered by about one-half of a blade height “H” from each other to permit pivot posts 112 of deflector blades 36 in adjacent blade columns 113 and 120 from interfering with each other.

Referring to FIGS. 2-4, the support frame 34 is adapted to be used with the front surface 70 of the backing sheet 40 disposed in a substantially vertical position with the deflector blades 36 in the closed position. A plurality of torsion springs 121 (dotted lines), one spring for each deflector blade 36, may be used adapted to bias the deflector blades 36 to the closed position in situations where the spray guard 10 is used at an angle off vertical and gravity alone does not cause the deflector blades 36 to completely move to the closed position. The deflector blades 36 are designed to hang vertically but pivot rearwardly toward backing sheet 40 when the overspray 12 of washing liquid 14 from spray gun 28 hits respective front surfaces 122 of blades 36 during spray washing of the silk screen 16. Momentum of the overspray 12 which contacts the deflector blades 36 causes rearward pivoting thereof during the contact to an open position (dotted lines) to pass and smoothly deflect the overspray 12 downwardly into respective of the vertical channels 53 without substantial splashing off the front surface 122 of backing sheet 40. The washing liquid 14 passes downwardly by gravitational force and outwardly through respective of the bottom openings 56 into collection tank 24. The deflector blades 36 subsequently individually close when momentum of the overspray 12 diminishes thereon to further minimize outward splashing of the washing liquid 14 while passing through the vertical channels 53. The deflector blades 36 which are not impacted by the overspray 12 remain in the vertical position covering the front openings 54 of the vertical channels 53. Respective rear surfaces 124 of deflector blades 36 direct the liquid 14 rearwardly and downwardly preventing outward splashing of the liquid 14 as it flows downwardly under the influence of gravity. This also minimizes propagation of vapor or fumes of volatile liquids 14 into ambient air and subsequent breathing by the person 26 unless a respirator (not shown) is used.

The stop members 38 are elongate so as to engage multiple deflector blades 36 and have a T-shaped cross-section. Each stop member 38 has a base leg 126 affixed to the front surface 70 of backing sheet 40, and a stop leg 128 which extends forwardly therefrom so as to engage a bottom portion 129 of the deflector blades 36 adjacent the bottom edge 110. The stop members 38 are adapted to engage and stop the rearward pivoting of the deflector blades 36 at a predetermined angle “A” to pass the overspray 12 into the vertical channels 53 of the vertical passageway 51 while not unduly obstructing the vertical channels 53 to facilitate flow of the washing liquid 14 thereby from above. The predetermined angle “A” is typically between about twenty and sixty degrees from vertical, with about forty-five degrees being preferred.

Referring to FIG. 1, the silk screen 16 is of conventional design, having a screen 130 stretched on a rectangular outer frame 132 comprised of a top member 1 34, a bottom member 136, and respective side members 138. Unmasked portions 140a-d of screen 130 pass ink 142 therethrough while one or more masked portions 144 thereof are fixed treated to prevent passing of the ink 142 therethrough. The silk screen 16 is placed on a t-shirt, paper, or other flat material (not shown) and the ink 142 is squeegeed to pass through the unmasked portions 140a-d of screen 130 to form the desired design.

The main frame 22 is adapted to slidably receive and support the spray guard 10 and the silk screen 16 in a generally vertical position for receiving the overspray 12 on the collection tank 24. The silk screen 16 is disposed slightly forward of the spray guard 10 and generally parallel thereto for cleaning. The main frame 22 is adjustable so as to receive and hold silk screens 16 of differing vertical heights “VH”.

The main frame 22 includes a base frame 146 and an inclined frame 148 which extends upwardly therefrom, each made of welded steel or aluminum for additional strength, though suitable plastic materials may be used. The base frame 146 is adapted to vertically support the spray guard 10 and the inclined frame 148 is adapted to horizontally support the spray guard 10 on the collection tank 24. The base frame 146 and inclined frame 148 are of mating rectangular configuration to collection tank 24.

The base frame 146 includes a pair of short members 150 and a pair of long members 152 each comprised of angle iron or other angle stock sized to fit the collection tank 24. A lower grooved spray guard holding member or support channel 154 of U-shaped cross-section interconnects the long members 152 and is sized to slidably receive a bottom edge 156 of the spray guard 10. A plurality of longitudinal drainage slots (not shown) extend through support channel 154 which correspond with bottom openings 56 of spray guard 10 when centered thereon to allow the washing liquid 14 to pass from the spray guard 10 into the collection tank 24. A lower grooved silk screen holding member or support channel 160 of L-shaped cross-section is disposed along support channel 154 interconnecting the long members 152 and is sized to slidably receive the bottom member 136 of the outer frame 132. A plurality of longitudinal drainage slots (not shown) extend through support channel 160 to permit drainage of liquid 14 which hits and bounces off silk screen 16 to drain into collection tank 24. A front plate 164 and a rear plate 166 are affixed to base frame 146, with front plate 164 being disposed slightly forward of the support channel 160 to form a transverse drainage slot 168, and disposed tilted slightly rearward to facilitate drainage of any overspray 12 of liquid 14 deposited thereon into collection tank 24. The configuration of drainage slots including slot 168 substantially retains fumes and vapors from volatile washing liquids 14 within collection tank 24 to prevent contamination of the ambient air.

The inclined frame 148 includes a pair of inclined members 170, a pair of connecting members 172, and a pair of vertical support members 174 each comprised of angle iron or other angle stock sized to fit onto the base frame 146. An upper grooved spray guard member or support channel 176 of U-shaped cross-section interconnects the inclined members 170 and is sized to slidably receive a top edge 178 of the spray guard 10. An upper grooved silk screen member or support channel 180 of U-shaped cross-section and sized to slidably receive the top member 134 of the outer frame 132 is movably connected to the support channel 176 by a pair of brackets 182 of L-shaped cross-section. A horizontal leg 184 of each bracket 182 is affixed atop the support channel 176. The support channel 180 is vertically adjustably connected to respective downwardly dependent vertical legs 186 of brackets 182 disposed parallel to support channel 176 using a plurality of bolts 187 which extend through respective holes (not shown) therethrough and through selected holes 188 through vertical legs 186. Respective nuts (not shown) secure bolts 187 in conventional manner. The holes 188 permit adjustment of main frame 22 to fit silk screens 16 of the various vertical heights “VH”.

The collection tank 24 includes a bottom portion 189 adapted to rest on the support surface 20 of table 25 or other flat surface, and an upper portion 190 of mating rectangular shape adapted to support the main frame 22. The collection tank 24 has an internal washing liquid collection chamber 191 adapted to receive and hold trapped washing liquid 14 moved from the spray guard 10 by gravity. Specifically, the collection tank 24 has a rectangular bottom wall 192 which rests on the support surface 20, and an upstanding peripheral wall 194 comprised of a front wall 196, a rear wall 198, and a pair of side walls 200 and which terminates at an upper support lip 202 adapted to receive and support main frame 22. The collection tank 24 is fabricated or molded from suitable metal or plastic material as listed above. An outlet tube (not shown) may be included to drain the liquid 14 directly into a larger collection tank (not shown) for subsequent transport and disposal, or into a conventional floor drain (not shown), depending on local environmental regulations.

The spray shroud 32 is illustrative of many possible designs to direct overspray 12 of liquid 14 into collection tank 24 and thus is shown only in dotted outline. The spray shroud 32 shown includes a lightweight tubular frame 204 having a plurality of elongate tubular members 205a-i made of conventional steel or aluminum tubing coated so as to resist corrosion and connected to the main frame 22 and the collection tank 24. A flexible spray deflector sheet 206 is affixed to and supported by the tubular frame 204 and is connected to the main frame 22 and collection tank 24 to direct the overspray 12 of washing liquid 14 into the collection tank 24. The deflector sheet 206 is made of suitable sheet plastic, plastic impregnated cloth, or other flexible material impervious to and non-degrading from the ink 142 and the washing liquid 14. The deflector sheet 206 may likewise be made of semi-rigid or rigid panels, molded from plastic, and the like. The frame 204 is adapted to spread and support the deflector sheet 206 to direct any overspray of liquid which misses the spray guard 10 into the collection tank 24.

A method of spray washing of an item such as the silk screen 16 using the spray collection system 18 comprises the steps of: 1) providing a louvered spray guard having a plurality of pivotable deflector blades which are biased to a closed position not to pass overspray thereinto; 2) positioning the item for washing in front of the spray guard; 3) directing a spray of washing liquid at the item to remove contaminates therefrom; and 4) receiving and trapping in the spray guard the overspray of the washing liquid directed at the item wherein momentum of the overspray which contacts individual deflector blades causes rearward pivoting thereof during the contact from the closed position to an open position to pass the overspray into the spray guard and stopped against a rear surface thereof while those deflector blades not contacted remain in the closed position without substantial splashing of the overspray off the spray guard.

In the method, the spray guard provided may have deflector blades of an outwardly convex shape which smoothly transition the overspray of washing liquid into the spray guard during receiving and trapping the overspray of the washing liquid. The deflector blades of the spray guard provided may be biased to the closed position by spring force, gravitational force, or a combination thereof. The method may further comprise the step of passing the washing liquid trapped in the spray guard to a collection tank.

The spray guard, spray collection system, and method of the present invention solves the problems with the prior art devices and methods for spray cleaning and washing of silk screens or other such items by: 1) using the non-hydrocarbon, aqueous cleaning liquids so as to use open air spraying without requiring the operator to use a respirator, and the hydrocarbon or other cleaning liquids if so desired; 2) trapping the overspray without significant splashing off the spray shield onto the floor by using curved deflector blades to smoothly transition the overspray downwardly: 3) inhibiting vapor propagation from the cleaning liquid into the atmosphere by immediately enclosing the trapped the cleaning liquid using deflector blades which are biased to a closed position and individually openable when impacted by overspray; 4) directing the enclosed cleaning liquid with removed ink, emulsion, and undesirable debris into the collection container for recycling or disposal using gravity; 5) being relatively inexpensive to purchase, operate, and maintain due to the simple, easily cleanable design thereof; 6) being of a portable, relatively compact design which is lightweight due to the plastic construction thereof, and which does not require external plumbing due to the self-contained design thereof, and 7) is adaptable for use with various spray cleaning and washing devices due to the design being easily changed in size and otherwise modified to suit.

Many modifications to the present invention are possible while staying within the same inventive concept. For example, the deflector blades may be of different designs such as planar rather than concavely curved, though planar blades are less effective in transitioning the overspray downwardly without splashing thereof. The size and number of blades and blade columns may be changed to suit the particular application. The blades of adjacent blade columns may be non-staggered if so desired. The stop members may be of different design.

Whereas this invention is here illustrated and described with reference to embodiments thereof presently contemplated as the best mode of carrying out such invention in actual practice, it is to be understood that various changes may be made in adapting the invention to different embodiments without departing from the broader inventive concepts disclosed herein and comprehended by the claims that follow.

1. A louvered spray guard for receiving and trapping overspray of a washing liquid during spray washing of an item, comprising:
a support frame which includes a rear surface adapted to be disposed in a position behind the item to stop the overspray;
a plurality of deflector blades pivotally mounted to said support frame spaced forward of said rear surface, said deflector blades being biased to a closed position substantially covering said rear surface of said support frame from the overspray and defining a passageway therebetween with a front opening and a bottom opening adapted for discharge of trapped washing liquid; and
wherein momentum of the overspray which contacts said deflector blades causes rearward pivoting thereof during the contact to an open position to pass the overspray into said passageway without substantial splashing thereof off said rear surface and downward gravitational drainage through said bottom opening, and subsequent closing thereof when momentum of the overspray diminishes thereon to minimize splashing of the washing liquid while passing through said chamber.

2. The spray guard according to claim 1, wherein the support frame is adapted to be used with the rear surface disposed in a substantially vertical position, and the deflector blades are adapted to hang downwardly under the influence of gravity biased to the closed position thereby.

3. The spray guard according to claim 1, wherein the support frame includes at least one spring adapted to bias the deflector blades to the closed position.

4. The spray guard according to claim 3, wherein the support frame includes at least one spring for each deflector blade.

5. The spray guard according to claim 1, wherein the deflector blades overlap one other when in the closed position.

6. The spray guard according to claim 1, wherein the support frame includes a backing sheet having the rear surface of substantially planar configuration, and at least two parallel members affixed to said rear surface in a laterally spaced relationship which define a channel of the passageway therebetween with the front opening and the bottom opening, the plurality of deflector blades being pivotally mounted to said parallel members forming at least one column of said deflector blades.

7. The spray guard according to claim 6, wherein there are at least three parallel members affixed to the rear surface in mutually laterally spaced relationship which define at least two of the channels of the passageway therebetween with respective of the front openings and the bottom openings, the plurality of deflector blades being pivotally mounted to said parallel members forming at least two columns of the deflector blades.

8. The spray guard according to claim 7, wherein the deflector blades of adjacent columns are vertically staggered by about one-half blade height.

9. The spray guard according to claim 6, wherein the parallel members comprise elongate strips having respective rear edges affixed to the rear surface.

10. The spray guard according to claim 6, wherein the parallel members each have a plurality of pivot holes therethrough disposed in substantially linear fashion, and the deflector blades each include a pair of pivot posts which coaxially extend laterally outwardly from each deflector blade adapted to be closely pivotally received within respective of said pivot holes of said parallel members.

11. The spray guard according to claim 6, wherein the support frame further comprises an upper angle member affixed to an upper edge of said support frame covering each upper opening of the passageway and an upper portion of each front opening.

12. The spray guard according to claim 6, wherein the support frame further comprises a lower strip affixed adjacent a lower edge of said support frame covering a lower portion of each front opening.

13. The spray guard according to claim 1, further comprising at least one stop member affixed to the support frame adapted to engage and stop the rearward pivoting of the deflector blades at a predetermined angle to pass the overspray into the passageway while not overly obstructing the passageway to facilitate flow of the liquid thereby.

14. The spray guard according to claim 13, wherein each stop member is elongate to engage multiple deflector blades with a T-shaped cross-section, having a base leg affixed to the rear surface of substantially planar configuration and a stop leg which extends forwardly therefrom so as to engage a bottom portion of the deflector blades.

15. The spray guard according to claim 13, wherein the predetermined angle is between about 20 and 60 degrees from vertical.

16. The spray guard according to claim 1, wherein the deflector blades each include a pair of pivot posts which coaxially extend laterally outwardly from each deflector blade adapted to be closely pivotally received within respective pivot holes of the support frame.

17. The spray guard according to claim 16, wherein the deflector blades each include a pivot rod and an integral deflector panel, the pair of pivot posts which coaxially extend outwardly from said pivot rod.

18. The spray guard according to claim 16, wherein the deflector blades are slightly flexible so as to pivotally mount to support frame by gentle longitudinally flexing to permit the pivot posts to fit within respective of the pivot holes.

19. The spray guard according to claim 1, wherein the deflector blades are of an outwardly convex shape which smoothly transitions the overspray of washing liquid into the passageway without splashing.

20. The spray guard according to claim 19, wherein the deflector blades include at least one reinforcement rib.

21. The spray guard according to claim 1, wherein the deflector blades are substantially rectangular in configuration as viewed from in front.

22. A louvered spray guard for receiving and trapping overspray of a washing liquid during spray washing of an item, comprising:
a support frame which includes a rear surface adapted to be disposed in a position behind the item to stop the overspray;
a plurality of deflector blades pivotally mounted to said support frame spaced forward of said rear surface, said deflector blades being biased to a closed position substantially covering said rear surface of said support frame from the overspray and defining a passageway therebetween with a front opening and a bottom opening adapted for discharge of trapped washing liquid; and
wherein said support frame includes a backing sheet having said rear surface of substantially planar configuration, and at least three parallel members affixed to said rear surface in a mutually laterally spaced relationship which define at least two channels of said passageway therebetween with respective of said front openings and said bottom openings, said plurality of deflector blades being pivotally mounted to said parallel members forming at least two columns of said deflector blades, said parallel members which comprise elongate strips having respective rear edges affixed to said rear surface, each having a plurality of pivot holes therethrough disposed in substantially linear fashion, and said deflector blades each include a pair of pivot posts which coaxially extend laterally outwardly from each deflector blade adapted to be closely pivotally received within respective of said pivot holes of said parallel members, and wherein momentum of overspray which contacts said deflector blades causes rearward pivoting thereof during the contact to an open position to pass the overspray into said passageway without substantial splashing thereof off said rear surface and downward gravitational drainage through said bottom opening, and subsequent closing thereof when momentum of the overspray diminishes thereon to minimize splashing of the washing liquid while passing through said chamber.

23. The spray guard according to claim 22, wherein the support frame is adapted to be used with the rear surface disposed in a substantially vertical position, and the deflector blades are adapted to hang downwardly under the influence of gravity biased to the closed position thereby.

24. The spray guard according to claim 22, wherein the support frame includes at least one spring adapted to bias the deflector blades to the closed position.

25. The spray guard according to claim 24, wherein the support frame includes at least one spring for each deflector blade.

26. The spray guard according to claim 22, further comprising at least one stop member affixed to the support frame adapted to engage and stop the rearward pivoting of the deflector blades at a predetermined angle to pass the overspray into the passageway while not overly obstructing the passageway to facilitate flow of the liquid thereby, each stop member comprising an elongate stop member of a T-shaped cross-section having a base leg affixed to the rear surface of substantially planar configuration and a stop leg which extends forwardly therefrom so as to engage a bottom portion of the deflector blades; and
wherein said deflector blades are substantially rectangular in configuration as viewed from in front and of an outwardly convex shape which smoothly transitions the liquid into the passageway, said deflector blades of adjacent columns being vertically staggered by about one-half blade height and overlap one other when in the closed position.

27. The spray guard according to claim 26, wherein the support frame further comprises an upper angle member affixed to an upper edge of said support frame covering each upper opening of the passageway and an upper portion of each front opening, and a lower strip affixed adjacent a lower edge of said support frame covering a lower portion of each front opening.

28. A spray collection system for placement on a support surface for receiving, trapping, and containing overspray of a washing liquid during spray washing of an item, comprising:
a louvered spray guard for receiving and trapping the overspray which includes a support frame with a generally planar rear surface adapted to be disposed in a position behind the item to stop the overspray, and a plurality of deflector blades pivotally mounted to said support frame spaced forward of said rear surface, said deflector blades being biased to a closed position substantially covering said rear surface of said support frame from the overspray and defining a vertical passageway therebetween with a front opening and a bottom opening adapted for discharge of trapped washing liquid, wherein momentum of overspray which contacts said deflector blades causes rearward pivoting thereof during the contact to pass the overspray into said vertical passageway without substantial splashing thereof off said rear surface and downward gravitational drainage through said bottom openings, and subsequent closing thereof when momentum of the overspray diminishes thereon to minimize splashing of the washing liquid while passing through said vertical chamber;
a main frame adapted to support said spray guard in a generally vertical position for receiving the overspray; and
a collection tank which includes a bottom portion adapted to rest on the support surface and an upper portion adapted to support said main frame, said collection tank having an internal washing liquid collection chamber adapted to receive and hold trapped washing liquid moved thereinto from said spray guard by gravity.

29. The spray collection system according to claim 28, wherein the main frame includes a base frame and an inclined frame which extends upwardly therefrom, said base frame being adapted to vertically support the spray guard and said inclined frame being adapted to horizontally support said spray guard on the collection tank.

30. The spray collection system according to claim 29, wherein the base frame and inclined frame are of rectangular configuration, and the upper portion of the collection tank is of mating rectangular shape.

31. The spray collection system according to claim 28, wherein the main frame is adapted to receive and hold a frame of a conventional silk screen with stretched fabric material immediately in front of the spray guard for cleaning.

32. The spray collection system according to claim 31, wherein the main frame includes respective upper and lower grooved silk screen-holding members disposed slightly forward of the spray guard adapted to slidably receive and support silk screens disposed generally parallel to said spray guard.

33. The spray collection system according to claim 31, wherein the main frame is adjustable so as to receive and hold silk screens of differing sizes.

34. The spray collection system according to claim 28, wherein the main frame includes respective upper and lower grooved spray guard-holding members adapted to slidably receive and support the spray guard.

35. The spray collection system according to claim 28, further comprising a spray shroud which includes a lightweight frame having a plurality of elongate members connected to at least one of the main frame and the collection tank, and a spray deflector sheet, said frame being adapted to spread and support said deflector sheet to direct any overspray of liquid into the collection tank.

36. A method of spray washing of an item, comprising the steps of:
providing a louvered spray guard having a plurality of pivotable deflector blades which are biased to a closed position not to pass overspray thereinto;
positioning the item for washing in front of the spray guard;
directing a spray of washing liquid at the item to remove contaminates therefrom; and
receiving and trapping in the spray guard the overspray of the washing liquid directed at the item wherein momentum of the overspray which contacts individual deflector blades causes rearward pivoting thereof during the contact from the closed position to an open position to pass the overspray into the spray guard and stopped against a rear surface thereof while those deflector blades not contacted remain in the closed position without substantial splashing of the overspray off the spray guard.

37. The method according to claim 36, wherein the spray guard provided has deflector blades of an outwardly convex shape which smoothly transitions the overspray of washing liquid into the spray guard during receiving and trapping the overspray of the washing liquid.

38. The method according to claim 36, wherein the deflector blades of the spray guard provided are biased to the closed position by a force chosen from the group consisting of spring, gravitational, and a combination thereof.

39. The method according to claim 36, further comprising the step of passing the washing liquid trapped in the spray guard to a collection tank.

40. The method according to claim 36, further comprising the step of:
passing the washing liquid trapped in the spray guard to a collection tank; and
wherein the spray guard provided has deflector blades of an outwardly convex shape which smoothly transitions the overspray of washing liquid into the spray guard during receiving and trapping the overspray of the washing liquid, and wherein the deflector blades of the spray guard provided are biased to the closed position by a force chosen from the group consisting of spring, gravitational, and a combination thereof.
